(19) United States
(12) Patent Application Publication
(10) Pub. No.: US 2018/0007066 A1
(43) Pub. Date: Jan. 4, 2018

(54) DETECTION OF PHISHING DROPBOXES

(71) Applicant: Vade Retro Technology Inc., San Francisco, CA (US)

(72) Inventor: Sebastien GOUTAL, San Francisco, CA (US)

(21) Appl. No.: 15/199,462

(22) Filed: Jun. 30, 2016

(51) Int. Cl. H04L 29/06

(52) U.S. Cl. CPC H04L 63/1416; H04L 63/1466; H04L 63/1483

(57) ABSTRACT

A computer-implemented method may comprise receiving, over a computer network, an email comprising a link to a fraudulent website of a counterfeited brand, the fraudulent website comprising at least one login page that comprises at least one field configured to accept user credentials; determining constraints on the user credentials that must be satisfied for the user credentials to be accepted by the fraudulent website when input into the at least one field; randomly generating at least some marker elements that satisfy the determined constraints; using the randomly-generated marker elements, generating fake user credentials that satisfy the determined constraints; assembling the generated fake user credentials into a marker that is specific to the counterfeited brand and to the fraudulent website; programmatically inputting the generated fake user credentials into the at least one field of the at least one login page of the fraudulent website; and publishing the marker injected into the fraudulent website to known email service providers.

### BACKGROUND

Phishing is the attempt to acquire sensitive data—such as credit card numbers, login credentials, social security numbers and the like for malicious purposes. Phishing often includes masquerading as a trustworthy entity in an electronic communication such as email or text message. Such trustworthy entities or brands may include banks (Chase, HSBC, Bank of America, BNP Paribas and the like), online payment services (PayPal, Apple Pay), email service providers (Gmail, Yahoo!, British Telecom, T-Online and the like), social networks (Facebook, LinkedIn), e-commerce websites (Amazon, Alibaba), etc.

### BRIEF DESCRIPTION OF THE DRAWINGS

FIG. 1 is an example showing fillable login and password input fields in a Hyper Text Markup Language (HTML) form.

FIG. 2 is an example of an email showing stolen credentials.

FIG. 3 is a flowchart showing aspects of a method that implements a generic marker submission scenario, according to one embodiment.

FIG. 4 is an example of a two-step login process for an online banking service.

FIG. 5 shows another example of a login page. This exemplary login page requires the customer to submit his or her PIN code by clicking on a randomized numeric keyboard.

FIG. 6 shows a list of actions that may be programmatically carried out by a web driver tool, according to one embodiment.

FIG. 7 is a flowchart of a computer-implemented method according to one embodiment.

FIG. 8 is a diagram of devices and systems configured according to one embodiment.

FIG. 9A is a diagram of devices and systems configured according to one embodiment.

FIG. 9B is a flowchart of a computer-implemented method according to one embodiment.

FIG. 10 is a block diagram of a computing device configured according to one embodiment.

### DETAILED DESCRIPTION

Phishing scams typically comprise several consecutive steps. In the following example, a worse-case scenario is contemplated, in which the intended victim is induced into compromising his or her confidential login information.

1. At the outset, the phisher sets up a counterfeited website by installing a phishing kit. A phishing kit may include website development software, complete with graphics, coding, content that can be used to create convincing imitations of legitimate websites. This counterfeited website mimics a well-known legitimate website and is designed to capture the sensitive login, personal and/or financial data of its victims.

2. The phisher sends out a phishing campaign using a selected electronic communication modality (email, text message . . . etc.). The phishing message at the heart of the phishing campaign may comprise text, graphics and/or other content that is intended to fool the user into believing that the originator of the phishing message is legitimate, to induce and prompt the victim to click on a fraudulent Universal Resource Locator (URL) that leads the victim not to a legitimate website but to a look-alike, fraudulent website.

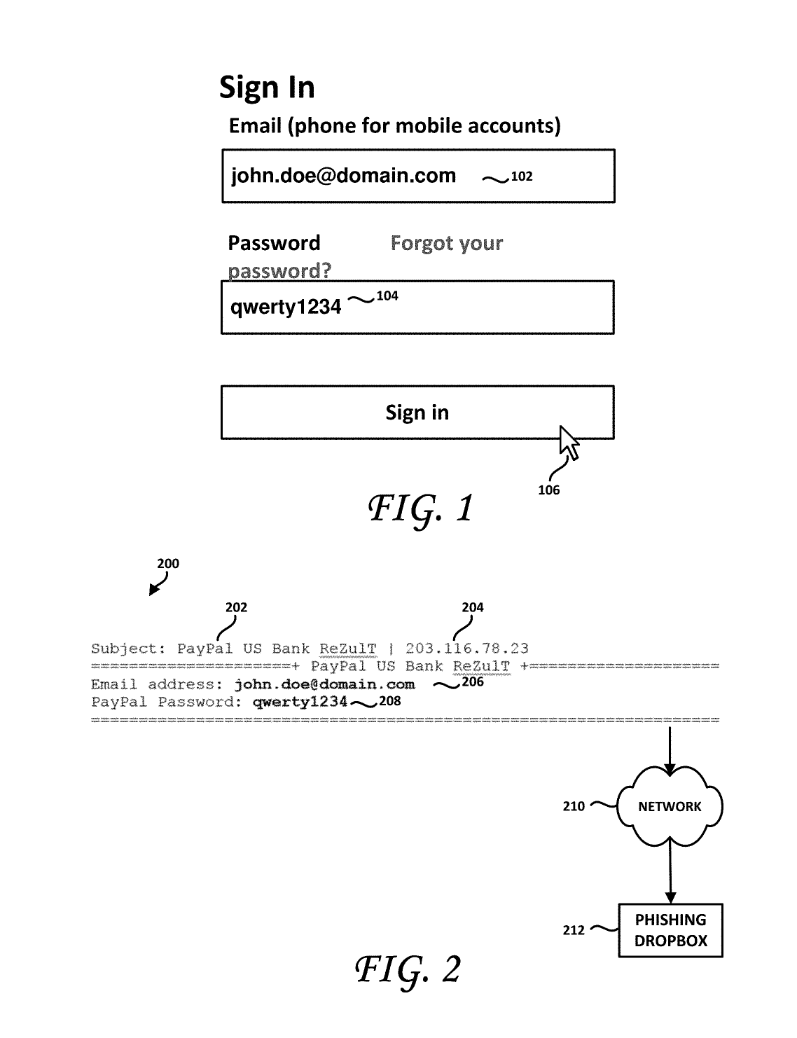

3. The victim receives the phishing message, and clicks on the fraudulent URL. The user's browser opens the fraudulent website and the victim, believing that the fraudulent website is actually legitimate, submits the requested credentials, usually login credentials or banking details. As shown in FIG. 1, the victim John Doe may be induced to provide his login credentials 102, 104 (in this case, an email address and a password) on a counterfeit webpage that may look identical to the intended legitimate webpage.

4. When the victim submits his credentials, as suggested at 106 in FIG. 1, an email may be generated that includes his login credentials, as shown at 200 in FIG. 2. The fraudulent email 200 may include the brand, company or product of the counterfeited website 202 (PayPal in this example), the Internet Protocol (IP) address of the victim (203.116.78.23 in this example), as shown at 204 and the user credentials entered into the fraudulent website. This may help the fraudster in determining that the credentials were not submitted by a robot (an automated piece of software). In this case, the credentials that the user was induced into providing under false pretenses include the user's email address (john.doe@domain.com in this example) as shown at 206 and the user's password (PayPal user password “qwerty1234” in this example), as shown at 210.

5. The fraudulent website programmatically forwards generated email 200 containing the sensitive, stolen user credential data over a computer network 210 to the phisher, typically a mailbox set up to receive the stolen information, which mailbox is commonly termed a “phishing dropbox”, as shown at 212.

It is a very common practice for phishers to collect the stolen credentials by email. The sensitive data is usually not stored on the fraudulent website to which the unsuspecting user was led because the website may be identified by the hosting company as being a fraudulent website and shutdown at any moment. As soon as the victim submits sensitive data on the fraudulent website, an email is sent to a specific email address—a phishing dropbox. The phisher then periodically fetches all emails delivered to the phishing dropbox and collects the stolen personal information. This stolen personal information may then be used to defraud both the user and the company whose website was spoofed and/or the stolen personal information may be aggregated and sold on some digital black market for use by other bad actors.

Phishing dropboxes such as shown at 212 are usually created on free webmail services such as Gmail, Yahoo! or AOL. Creating an email account on a free webmail is very easy and, importantly for thieves, does not require a proper identification to activate the account. This is a significant differentiator, as phishers need to remain anonymous, as their activity is illegal.

One method of deterring and interdicting phishers includes the detection of these phishing dropboxes. Such identification enables the identification of the victim and enables the crime to be reported to both the identified victim and to the company/brand associated with the spoofed website. The detection of these phishing dropboxes also enables the free webmail provider to be notified, to allow them to prevent phishers from continuing their use of the free webmail service in furtherance of their crimes. Indeed, detecting these phishing dropboxes allows the email host to close down the email account of the phisher, since the purpose to which the phisher's email account is to defraud users, which obviously does not respect the terms of use to which the phisher agreed when setting up his or her email account. Toward that end, one embodiment provides free webmail providers with the information they need to identify phishing dropboxes, which phishing dropboxes can then be shut down as soon as they are identified.

One embodiment comprises generating and submitting, to the free webmail providers, data structures called markers. The markers contain actionable information that enables the free webmail providers (for example) to filter their inbound Simple Mail Transfer Protocol (SMTP) traffic for the information in such markers, thereby allowing them to identify any phishing dropboxes on their service and to thereafter shut them down.

The most common phishing use case, the theft of login credentials, is detailed herein. Enabling mail providers to identify and shutdown phishing dropboxes, according to one embodiment, begins with the generation of a marker. A marker, according to one embodiment, may comprise one or more of the following features:
A marker may be specific to a brand (PayPal, Chase, Amazon . . . ).
A marker may comprise one or several elements that represent login credentials specific to the brand, company, product or website. Markers may comprise two elements, such as a login and a password, although a greater number of elements may be included.
Part or all of one or more of the constituent elements of the marker may be generated randomly (using different methods such as, for example, random-number generator, dictionaries, cryptographic hashing algorithms and the like).
Each element of the marker satisfies the constraints placed on the login credentials by the brand or spoofed company on its legitimate website. An example of such constraints is: Company X requires the first element to be a sequence of uppercase letters and digits that does not exceed 32 characters. It is important to satisfy the constraints of the brand, product or company login credentials because the fraudulent website may check the format of data submitted by the victim.
The constituent elements of the marker should have high entropy. In the present context, “high entropy” means that the probability that the randomly-generated data already exists in the digital world is very close to zero. A consequence of this high entropy is that the marker exhibits a high degree of randomness and that the marker is, therefore, highly unlikely to interfere with existing legitimate login credentials. Indeed, the odds that legitimate login credentials are the same as the made up, fake credentials embodied as the constituent elements of the marker are believed to be vanishingly small.

Detailed below are a few examples of markers for different brands/products/companies, according to one embodiment. For example, the free webmail service provider Gmail requires users to login using a Gmail address and a password. The constraints placed on Gmail login credentials include the following: the email address must contain the gmail.com domain and the password must be a sequence of at least 8 ASCII characters.

JSON (JavaScript Object Notation) is an open-standard, language-independent data format that uses human-readable text to transmit data objects consisting of attribute-value pairs. It is the most common data format used for asynchronous browser/server communication (AJAJ), largely replacing XML. A JSON-formatted example of a Gmail marker, according to one embodiment, is provided below:

```
{
  ″marker″: {
    ″brand″: ″gmail″,
    ″elements″: [ {
      ″type″: ″login″,
      ″value″: ″angelica.gomes63718@gmail.com″
    }, {
      ″type″: ″password″,
      ″value″: ″Xe4U89@df$r092wt5″
    } ]
  }
}
```

According to one embodiment, a marker may comprise an identification of the brand/product/company and two (or more) elements. The brand, in this case, is Gmail and the first element of the Gmail-specific marker is a login and the second element is a password. The first element, in this example, is a made-up but properly-constructed email address; namely, angelica.gomes63718@gmail.com (which is of the type and format expected by Gmail) and the second element of the marker is a password that may be both randomly-generated and that satisfies all Gmail-mandated constraints. In this example, the value of the randomly-generated password is Xe4U89@df$r092wt5. The password itself has high entropy, in that the probability that such data exists elsewhere is very low. The combination of the made-up login angelica.gomes63718@gmail.com and the randomly-generated password Xe4U89@df$r092wt5 has even higher entropy, meaning that it is exceedingly unlikely that a legitimate user shares the same login/password pair as the made-up, fake credentials consisting of angelica.gomes63718@gmail.com and Xe4U89@df$r092wt5.

Another example is presented herewith, with respect to the e-commerce website Amazon.com. This ecommerce site requires an email address or a phone number and a password for login. A password that is acceptable to Amazon is any sequence of at least 8 characters and at most 128 characters. Allowed characters are letters, digits and the following special characters: !@#$%̂&*( )_+−=[ ]{ }|′. An example of a marker data structure suitable for Amazon, in JSON, is given below:

```
{
  ″marker″: {
    ″brand″: ″amazon″,
    ″elements″: [ {
        ″type″: ″login″,
        ″value″: ″aaronsmith89@yahoo.com″
    }, {
        ″type″: ″password″,
        ″value″: ″hX#418+jKtr0984″
    } ]
  }
}
```

The marker, in this case, comprises the brand amazon and the fake, made-up random login/password pair. The login may comprise an email address (which satisfies the amazon-mandated constraint of being at least 8 characters in length and a most 128 characters, including special characters) and the password is the programmatically and randomly-generated string hx#418+jKtr0984. The combination satisfies the amazon constraints for login purposes, yet is highly unlikely to be the same as anyone's legitimate amazon login credentials.

Not all login credentials consist of an email address and a password. For example, the online banking service Société Générale requires customers to login using a customer ID and a Personal Identification Number (PIN) code. Société Générale places the following constraints on its customer ID and PIN numbers: the Customer ID must be a sequence of 8 digits and PIN code must be a sequence of 6 digits.

An example of a JSON-formatted marker suitable for Société Générale, according to one embodiment is shown below:

```
{
  ″marker″: {
    ″brand″: ″societegenerale″,
    ″elements″: [ {
      ″type″: ″customer_id″,
      ″value″: ″56219177″
    }, {
      ″type″: ″pin_code″,
      ″value″: ″451709″
    } ]
  }
}
```

As shown, the marker identifies the brand “societegenerale”, and defines type/value pairs for both the customer ID and the PIN code. The JSON-formatted marker, in this manner, provides a uniform data structure for storing fake login credentials, that may thereafter be used to identify and shut down phishing dropboxes. The programmatic generation of markers and the uniformity of their structure enables renders this solution highly scalable and suitable for widespread adoption across the Enterprise.

According to one embodiment, markers may be programmatically-generated and the constituent elements thereof injected into the fraudulent websites pointed to by the URLs in phishing messages (e.g., emails or other forms of electronic messages) received by customers and users. According to one embodiment, a computer-implemented method may include obtaining the URL of at least one fraudulent website. Toward that end, one embodiment may include obtaining a list comprising a plurality of known fraudulent websites. For each fraudulent website, a brand specific, company-specific or otherwise personalized marker may be generated and the constituent elements thereof (including the fake credentials) programmatically provided to the fraudulent website, by submitting the made up user credentials stored in the marker to the username/customer ID (and the like) field and to password fields, or functionally similar input fields. Thereafter, the same markers provided to the fraudulent websites may be published. Such publication may include sending markers to, for example, the brand, the free email hosting company, the customer and optionally, others such as law enforcement. Once in possession of this information, they may identify the phishing dropboxes and/or take corrective action. For example, the free webmail provider may cancel the identified dropbox and the user may change his or her login information, now that their previous login information has been compromised.

According to one embodiment, one embodiment may include downloading a list of fraudulent websites from a third party such as http://www.isitphishing.org. For each fraudulent website, at least the following information may be provided:
The URL of the fraudulent website. This URL may be a final URL (no redirection to any other page);
A brand, company or other entity (Amazon, Chase, PayPal, Gmail and the like) associated with the fraudulent website;
A flag that indicates whether the fraudulent website is still online; and
The IP address of the fraudulent website.

Indeed, the list of fraudulent websites assumes the following: each record in the list is a fraudulent website that is identified by an URL, is associated with exactly one IP address (thanks to the DNS resolution of the URL), is associated with exactly one brand/product/company and has a status flag that indicates that the site is online.

Below is an example of a JSON-formatted data structure comprising a list of such fraudulent websites pointed to by URLs in phishing messages:

```
{
  ″urls″: [
    {
      ″url″: ″http://paypal_phishing_url.com/″,
      ″brand″: ″paypal″,
      ″status″: ″online″,
      ″ip″: ″245.67.189.13″
    },
    {
      ″url″: ″http://amazon_phishing_url.com/″,
      ″brand″: ″amazon″,
      ″status″: ″online″,
      ″ip″: ″167.200.10.45″
    }
  ]
}
```

The first phishing URL listed in this data structure points to a fraudulent website that spoofs the paypal.com website and is currently online at IP address 245.67.189.13. The second phishing URL listed in this data structure is a fraudulent amazon website that is currently online at IP address 167.200.10.45.

The inclusion of the IP address is significant as, according to one embodiment, more than one marker should not be submitted to the same IP address. Indeed, submission of more than one marker to a single IP address may trigger an identification, by the phisher, of the credentials as being illegitimate and submitted by, for example, a security vendor. It is quite common that fraudulent websites try to detect robots developed by security vendors by checking the number of HTTP connections coming from the same IP address.

Next, a marker specific to the identified fraudulent website may be generated. This marker, according to one embodiment, may be generated to satisfy all of the constraints specified by the legitimate website being spoofed by the fraudulent website. The marker may be generated using different methods using, for example, random-number generators, dictionaries, cryptographic hashing algorithms and the like. However generated, the marker to be submitted to the fraudulent website pointed by the URL in the phishing message may be configured to satisfy the pre-existing constraints placed on legitimate login credentials on the legitimate website.

According to one embodiment, a scenario (including a pre-defined sequence of steps or actions) may be used to submit the marker elements to the fraudulent website. The scenario may be generic or specific to the brand, company or organization spoofed by the fraudulent website. The use of a generic scenario is possible in many cases, as a significant proportion of login scenarios are similar to one another. For example, it is very common that the login process may be carried out by filling login and password HTML input fields, and by submitting the resultant HTML form.

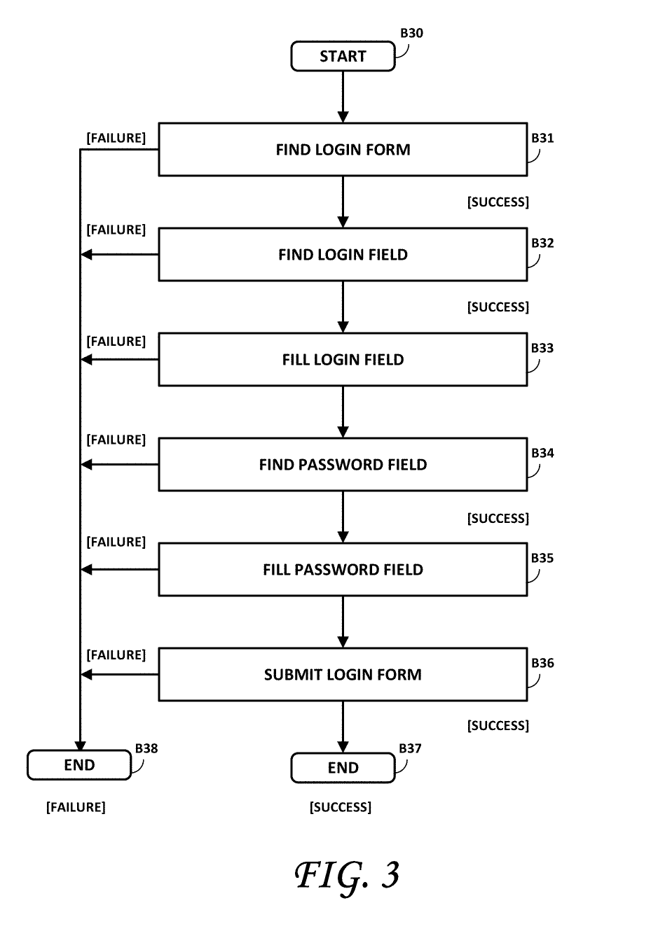

FIG. 3 is a flowchart showing aspects of a method that implements a generic marker submission scenario, according to one embodiment. The method of FIG. 3 begins at B30, wherein a login form (a webpage that comprises fillable fields that request the user's credentials, for example) is programmatically identified, as shown at B31. If no login form is found, the method ends in failure, as shown at B38. If a login form is found, a login field (or functionally-similar field) of the identified login form is found at B32 and filled in at B33 with the first element of the programmatically-generated marker. If the login field is not found or cannot be filled, the method proceeds to B38, which is indicative of a failure to submit the made-up credentials defined by the marker to the fraudulent website. At B34, the password field (or functionally-similar field) of the identified login form is found and filled in at B35. Similarly, if the password field is not found or cannot be filled in with the second element of the generated marker, the submission of the generic marker is deemed a failure. As the input fields of the login form are all filled in, the login form may now be submitted, as shown at B36, successfully ending the method at B37. Should the filled-in login form not be successfully submitted, the method proceeds to B38, which is indicative of a failure of the marker submission attempt.

In contrast to a generic scenario, a scenario is brand-specific if the brand login page requires interactions that are specific to the brand/product/company. Such brand-specific interactions may include, for example:
The submission of more than one HTML form;
Requiring the user to enter a numeric value (user ID, PIN code and the like) using a numeric keyboard;
Requiring the user to submit biometric information;
Requiring the user to provide extra identification information such as company, first name, last name, birthdate, social security number or zip code, to identify but a few possibilities; and/or
Requiring the user to provide information or carry out an action that may not customarily requested by other login pages.

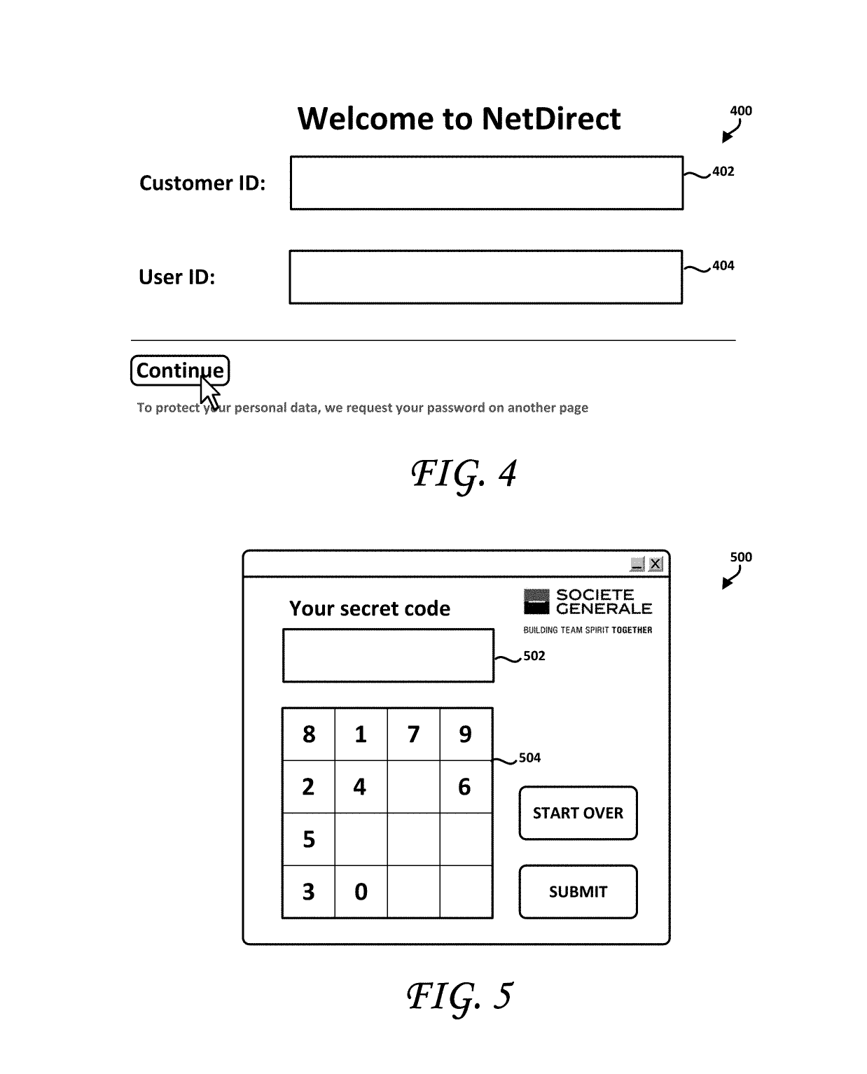

For example, FIG. 4 shows an example of a login page 400 for a fictitious business online banking service called NetDirect. NetDirect requires the login process to be carried out in two steps:
The first step requires the user to fill out a first form and provide a valid customer ID 402 and a valid user ID 404. In this case, the customer ID is the identifier of the company and user ID is the identifier of the employee. The user must then click the “Continue” button;
After the user clicks continue on the first webpage 400, a second webpage is displayed. This second page requests a password that is specific to the employee. As the login is specific to NetDirect, a NetDirect-specific scenario should be written to programmatically submit the requested information in the proper format and in the required order.

Another example is Société Générale login page shown at 500 in FIG. 5. This login page requires the customer to submit his or her Secret Code by clicking on a numeric keyboard 504. The keys of this numeric keyboard are randomized for security reason. Automation of this login process will require the use of OCR (Optical Character Recognition) to identify the randomly positioned numeric keys.

According to one embodiment, scenarios as disclosed herein may be executed using web driver technology. Web driver technology allows a web browser (Google Chrome, Mozilla Firefox, Safari) to be programmatically controlled. An example of such technology is Selenium WebDriver, available from www.seleniumhq.org, and that can be controlled by popular programming languages, including Java, Python, Ruby, Perl and C#.

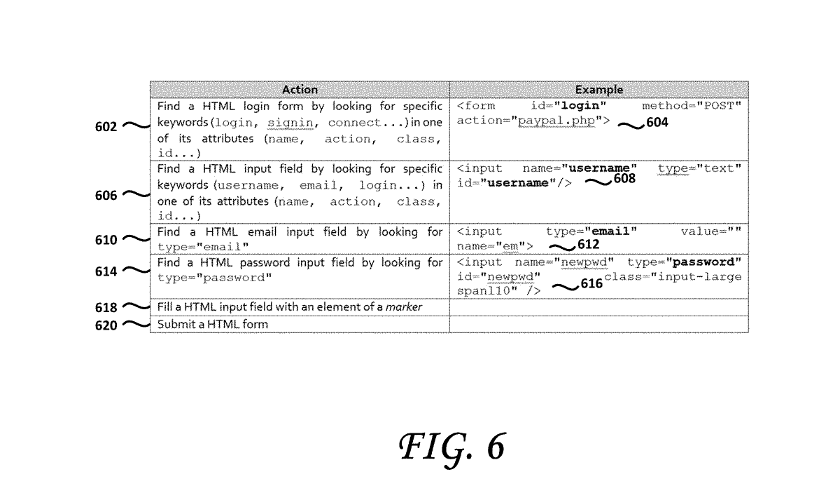

According to one embodiment, a number of actions may be carried out on a fraudulent website using web driver technology. These actions include, for example, publishing markers submitted to fraudulent websites. FIG. 6 shows non-exhaustively listed exemplary actions that may be carried out by the web driver tools. As shown at 602, the web driver technology may be used to find an HTML login form by examining the form for specific keywords (such as, for example, login, Sign in, connect and the like) in one of its attributes (name, action, class, id and the like). One example of a form that would be identified by web driver tools as an HTML login form is shown at 604 in FIG. 6. As shown at 606, web driver technology may also examine a login page of a fraudulent website to identify specific input fields, by looking for keywords (such as, for example, username, email, login) in one of its attributes (for example, name, action, class, id). An example of a username input field that would be identified by such web driver technology is shown at 608 as <input name=“username” type=“text” id=“username”/>. Web driver technology can also be used to find HTML input fields in a fraudulent website by, for example, looking for an input field of the “email” type, as shown at 610, 612. Similarly, HTML password fields may be identified as shown at 614, by looking for an input field of the “password” type. An example of such is shown at 616 in FIG. 6. The web driver technology may also both fill in HTML fields with the appropriate marker elements as shown at 618 and submit the programmatically-filed in HTML login form as shown at 620.

As noted above, marker elements submitted to fraudulent websites may be published or otherwise provided to free webmail providers. Brand-specific markers submitted to fraudulent websites will also be published to the concerned brand, company or organization. Along with the marker, the date on which the marker elements were injected into the fraudulent website may also be provided, along with the IP address of the fraudulent website.

An example of a data structure with which a marker may be published to Amazon.com is shown below:

```
{
  ″marker″: {
    ″brand″: ″amazon″,
    ″elements″: [ {
      ″type″: ″login″,
      ″value″: ″aaronsmith89@yahoo.com″
    }, {
      ″type″: ″password″,
      ″value″: ″hX#418+jKtr0984″
    } ],
    ″injections″: [ {
      ″date″: ″2016-01-01T08:27:44+0000″,
        ″url″: ″http://amazon_phishing_url_1.com/″,
      ″ip″: ″32.190.45.241″
    }, {
      ″date″: ″2016-01-01T09:03:01+0000″,
        ″url″: ″http://amazon_phishing_url_2.net/″,
      ″ip″: ″119.93.230.12″
    }, {
      ″date″: ″2016-01-01T09:08:45+0000″,
        ″url″: ″http://amazon_phishing_url_3.org/″,
      ″ip″: ″230.38.137.145″
    } ]
  }
}
```

Here, the publication of the marker provides the free webmail provider (and amazon.com and/or others) with the details of the marker elements submitted to the fraudulent websites. In this illustrative case, the marker submitted included elements corresponding to a login/password pair of (aaronsmith89@yahoo.com, hX#418+jKtr0984). The fraudulent websites to which this marker was injected are also detailed, by date, time, URL and IP address. In this case, the aaronsmith89@yahoo.com, hX#418+jKtr0984marker was submitted to three different fraudulent websites; namely amazon_phishing_url_1.com, amazon_phishing_url_2.com and amazon_phishing_url_3.com, at three different IP addresses.

Providing the details of the marker elements submitted to these websites, according to one embodiment, enables the free webmail providers to take appropriate action. Such appropriate action, in most cases, will include shutting down the webmail account of the phishing dropbox. The free webmail provider, using the published information, will then be able to detect phishing dropboxes. This may be carried out by, for example, filtering the inbound SMTP traffic and looking for the information in the published markers. In the previous example, the free webmail provider will identify phishing dropboxes by looking for inbound SMTP traffic that contains aaronsmith89@yahoo.com and hX#418+jKtr0984. Free webmail providers may also identify phishing dropboxes by inspecting inbound SMTP traffic coming from the IP addresses where the markers have been injected. In the previous example, SMTP traffic from 32.190.45.241, 119.93.230.12 and 230.38.137.145 would be considered to be highly suspect, since these websites have previously been identified as fraudulent websites that spoof established, well-known legitimate websites. Furthermore, according to one embodiment, the inspection may be refined using the time of injection, thanks to the date field in the published markers.

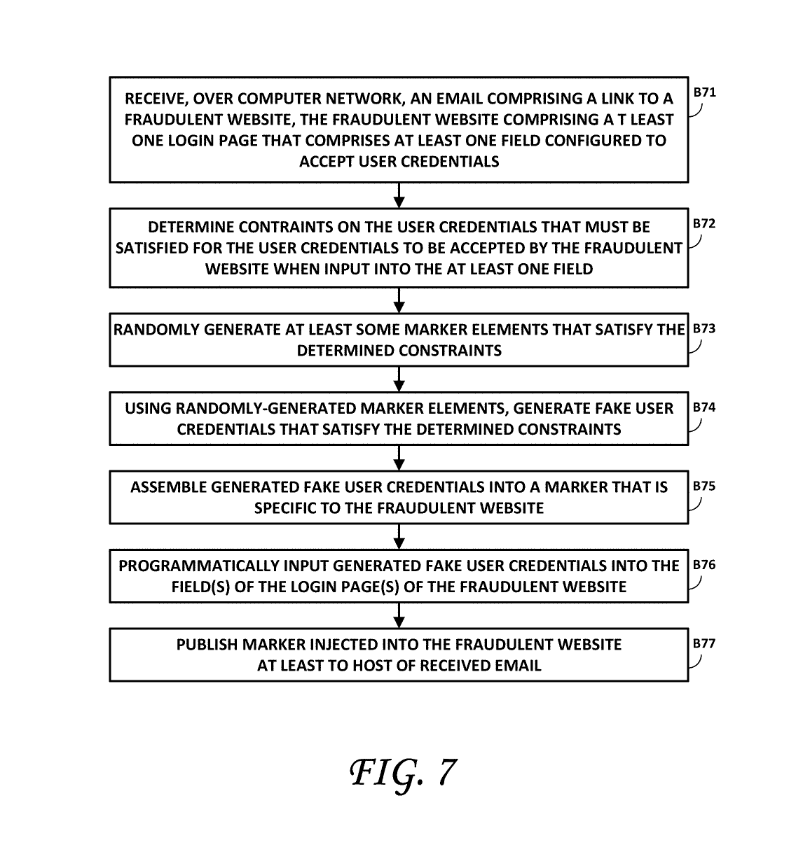

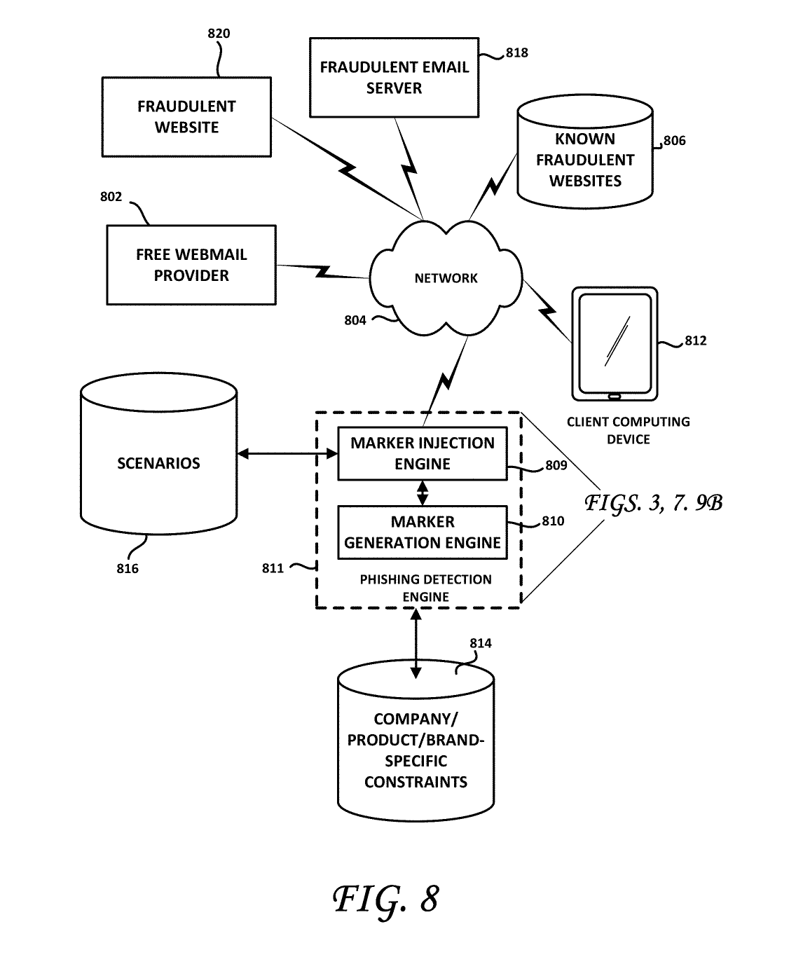

FIG. 7 is a flowchart of a computer-implemented method according to one embodiment. As shown therein, such a method may comprise receiving, over a computer network, an email comprising a link to a fraudulent website, as shown at block B71. The fraudulent website may include one or more login pages (or functionally-similar pages) that comprise one or more input fields configured to accept user credentials. Block B72 calls for determining constraints (linked to the brand/product/company that is counterfeited by the fraudulent website) on the user credentials that must be satisfied for the user credentials to be accepted by the fraudulent website when input into input field(s) of the login page(s). At least some marker elements may then be randomly generated or one or more existing high-entropy marker elements may be selected, in a manner that satisfies the determined constraints. For example, the generation of the marker elements may be carried out using high-entropy hardware or software random-number generators, dictionaries, cryptographic hashing algorithms, to identify but a few possibilities. Using the randomly-generated or selected marker elements, fake user credentials may be generated that satisfy the determined constraints, as called for at B73. Block B74 calls for assembling the generated fake user credentials into a marker that is specific to the fraudulent website. According to one embodiment, the same marker may be utilized for several fraudulent websites of the same brand, but with a different IP address. In this manner, the burden of inbound traffic filtering can be lessened for the webmail provider, who can then use a shorter list of markers in its filtering. The generated fake user credentials may then be programmatically input into the input field(s) of the login page(s) or functional equivalent of the fraudulent website, as shown at B75. The marker whose fake credentials were injected into the fraudulent website may then be published (e.g., sent or otherwise provided) at least to the host of the received email (in many cases, a free webmail provider such as Gmail or Yahoo), as shown at B77. It is worthy of note that the webmail provider may not be known. However, it is not unreasonable to assume that the majority of the phishing dropboxes will be hosted by a limited number of free webmail providers such as, for example, Gmail, Yahoo! and the like.

According to one embodiment, the computer-implemented method may further comprise retrieving, over the computer network, a list of the fraudulent websites from a database of known fraudulent websites and the Internet Protocol (IP) addresses therefor. In one embodiment, determining constraints may comprise comprises consulting a database that stores the constraints on the user credentials of the fraudulent websites. In this context, consulting the database may comprise downloading a list of the fraudulent databases and periodically checking the database for updates to this list of fraudulent databases. Randomly generating the marker elements may be carried out such that resultant fake credentials have high entropy (randomness). The fraudulent website may be configured to spoof a well-known website of an existing company (such as, for example, chase.com or amazon.com or paypal.com), product or brand. According to one embodiment, generating the fake user credentials and assembling the generating fake credentials into the marker may be carried out such that the assembled marker is specific to the existing company, product or brand. Programmatically inputting the generated fake user credentials may comprise executing a selected generic scenario or a brand, product or company-specific scenario. Whether generic or brand, product or company-specific, the scenarios may be configured to determine the manner in which the generated fake user credentials are inputted into the fraudulent website. According to one embodiment, programmatically inputting the generated fake user credentials into the input field(s) of the login page(s) of the fraudulent website is carried out only once per IP address.

Assembling the generated fake user credentials into a marker may further comprise adding, to the marker, the IP address of the fraudulent website, the date (and time) on which the generated fake user credentials were programmatically inputted into the input field(s) of the login page(s) of the fraudulent website. Other information may also be added to or in place of the previously-described information. According to one embodiment, publishing may comprise sending a copy of the assembled marker data structure to the provider of the email service of the received email (in many cases, a free webmail provider) and to a company or brand spoofed by the fraudulent website. These markers enable the recipient thereof to detect the phishing dropbox or dropboxes and to take curative action—which may include deleting the phishing dropbox and canceling the account of the owner of the dropbox.

FIG. 8 is a block diagram of a computer system configured for the detection of phishing dropboxes, according to one embodiment. As shown therein, a free webmail provider 802 (not part of the present phishing dropbox detection system, per se) may be coupled to a network (including, for example, a LAN or a WAN including the Internet) 804. The free webmail provider 802 may unknowingly host a phishing dropbox and will receive, according to one embodiment, the markers containing the fake credentials enabling them to identify the phishing dropboxes. A fraudulent email server 818 may also be coupled to the network 804. The fraudulent email server 818 may be configured to send the phishing emails to client computing devices 812 over the network 804. The fraudulent email server 818 may be a rented server or a hacked server. The phisher may configure a Message transfer Agent (MTA), an email server, to send phishing emails to its victims A fraudulent website 820 may also be coupled to the network 804. The fraudulent website may be hosted on a rented server or on a hacked server. A database 806 of known fraudulent websites may also be accessible over the network 804. A phishing detection engine 811 may also be coupled to the network 804. The phishing detection engine may comprise a marker generation engine 810 and a marker injection engine 809. The marker injection engine 809 may be configured to inject the high entropy randomly-selected (or selected pre-existing) elements of the marker into the fraudulent website pointed to by the URL in the phishing email sent to the client computing device 812. The manner in which the elements of the marker are injected into the fraudulent database may be defined by a scenario stored in a scenario database 816. The databases 806, 814, 816 may be a single database, individual databases and/or the information contained therein may be distributed in one or more devices and one or more locations on the computer network. Some or all of the information stored in the databases 806, 814, 816 may be stored in the phishing detection engine 811, also coupled to the computer network 804. Some or all of the functionality of the phishing detection engine 811 may be coupled to or incorporated within the client computing device 812. According to one embodiment, the phishing detection engine 811 may be configured to carry out the functionality and methods described herein above and, in particular, with reference to FIGS. 3, 7 and 9B. Engines 809 and 810 may be combined. According to one embodiment, the phishing detection engine may be further configured to carry out some or all of the methods and functionality disclosed with respect to commonly-assigned U.S. patent application Ser. No. 14/597,142 filed on Jan. 14, 2015, U.S. patent application Ser. No. 14/542,939 filed on Nov. 17, 2014, U.S. patent application Ser. No. 14/861,846 filed on Sep. 22, 2015, U.S. patent application Ser. No. 15/063,340 filed Mar. 7, 2016 and U.S. patent application Ser. No. 15/070,479 filed on Mar. 15, 2016, the disclosures of each being incorporated herein in their entireties.

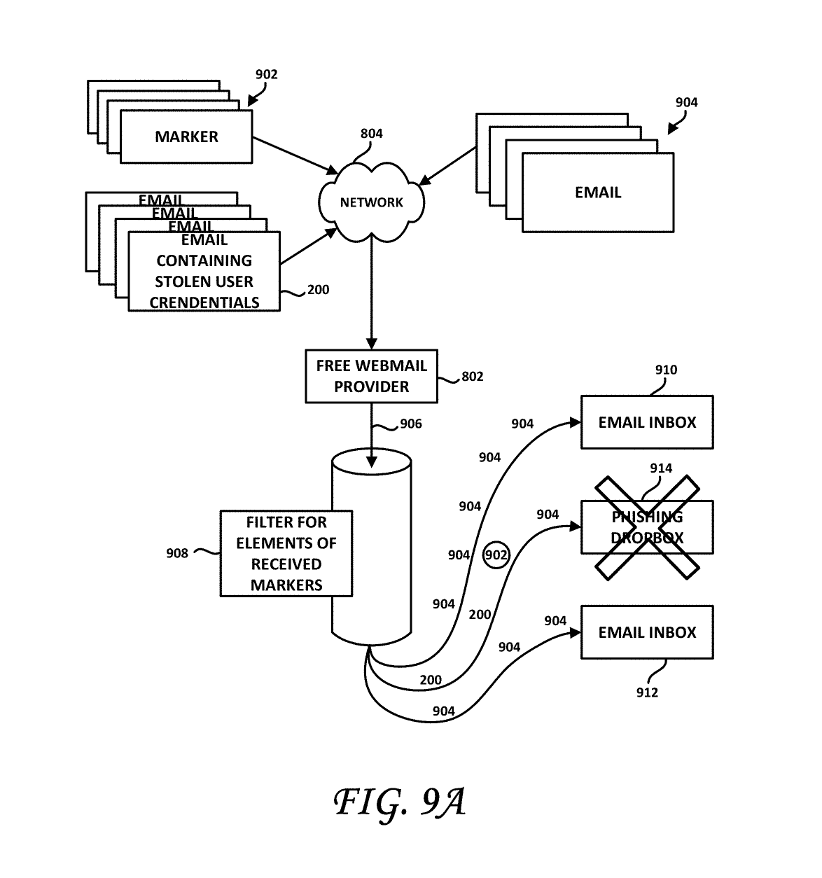

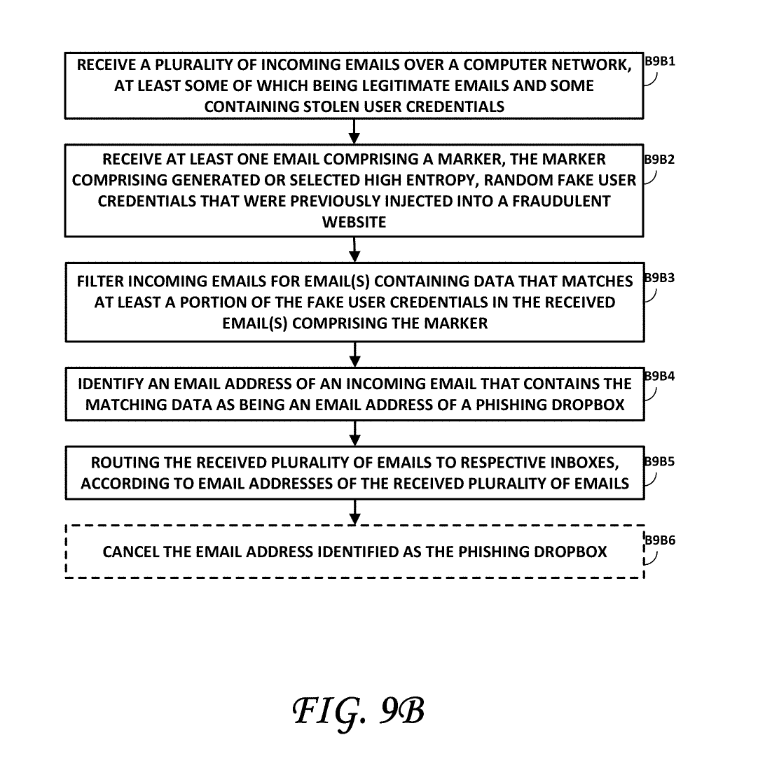

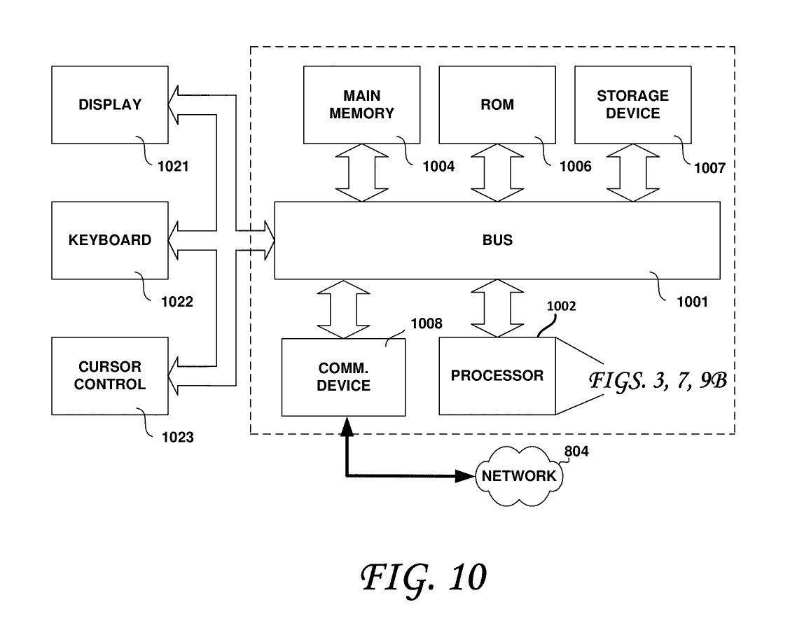

As shown, the phishing detection engine may comprise a marker generation engine 810 and a marker injection engine 809. The marker generation engine 810 may be configured to generate the elements of the fake credentials (or select from pre-existing marker elements) that are to be input into the login fields of the identified fraudulent website and the marker injection engine 809 may be configured to programmatically input the generated fake credentials into their appropriate input fields of the fraudulent website. Web driver technology may be used for this purpose; that is, to remotely and programmatically control the fraudulent website to accept and submit the fake credentials of the generated marker. Programmatic detection of a phishing email, the identification of fraudulent websites, the generation of markers and the injection of such markers into the identified fraudulent websites may be readily scaled and automated to provide high-volume industrial-grade protection against phishing emails and the systematic eradication of phishing dropboxes as soon as they are detected. FIG. 9A shows further aspects of a method according to one embodiment, from the point of view of the email host, such as the free webmail provider 802. As shown therein, free webmail provider 802 (or whatever service that is hosting the email used to send the phishing emails) may receive a great many emails. Such emails may include both legitimate emails as shown at 904 and emails containing stolen user credentials 200 (as shown in FIG. 2). A priori, the free webmail provider does not know which of the many email addresses it manages, if any, is being used as a phishing dropbox. However, the free webmail provider may also be provided with one or more markers 902, each containing the faked user credentials injected into a separate fraudulent website pointed to by the URL in the phishing emails, as described above. Using the fake user credentials stored in the received markers, the free webmail provider 802 may filter its incoming data, looking for strings that match the randomly-generated marker elements as suggested at 908, and having identified such, determine the destination email address thereof. This destination email address may then fairly be characterized as a phishing dropbox. The free webmail provider 802 may then take curative action, such as canceling the email address 914 (as suggested by large “X”), and giving relevant information to law enforcement, for example. As shown, legitimate emails 904 are forwarded to email inboxes 910 and 912. Legitimate email messages 904 may even be addressed to the phishing mailbox 914, as may be several emails containing stolen user credentials 200. However, according to one embodiment, one email (shown by the circled numeral 902), may also include the elements of a marker 902 sent to or published to the free webmail provider 802, in accordance with an embodiment described herein. It is this single email containing the fake credentials of the marker 902 that enables the free webmail provider to positively identify phishing dropboxes from the typically many, many other legitimate email addresses under its management.

FIG. 9B is a flowchart of a method according to one embodiment. As shown therein, a computer-implemented method of detecting a phishing dropbox may comprise receiving a plurality of emails over a computer network, at least some of the received plurality of emails being legitimate emails and at least some of the plurality of received emails comprising stolen user credentials, as shown at block B9B1. B9B2 calls for receiving one or more emails (or other form of electronic message), the email(s) comprising a marker comprising generated or selected high entropy, random fake user credentials that were previously injected into a fraudulent website. Block B9B3 calls for filtering the incoming emails for one containing data that matches the fake user credentials in the received email(s) or electronic message(s) comprising the marker and block B9B4 calls for identifying the email address of an incoming email that contains the matching data as being an email address of a phishing dropbox. At B9B5, the received plurality of emails may be routed to respective inboxes, according to email addresses of the received plurality of emails. It is important that the markers published to webmail providers have sufficiently high entropy such that inbound traffic filtering (see reference numeral 908 in FIG. 9A) only detects fraudulent emails i.e. mails sent to the phishing dropbox. False positives, such as webmail provider detecting emails that are not related to a suspected phishing dropbox, may problematic for the webmail provider, both in terms of breach of privacy and confidentiality as well from a technical point of view, as false positives degrade the webmail provider's efficiency in sorting through the large volume of emails.

Optionally, as shown at B9B6, the email address identified as the phishing dropbox may be canceled and/or other actions may be taken, with respect to the identified phishing dropbox.

Any reference to an engine in the present specification refers, generally, to a program (or group of programs) that perform a particular function or series of functions that may be related to functions executed by other programs (e.g., the engine may perform a particular function in response to another program or may cause another program to execute its own function). Engines may be implemented in software and/or hardware as in the context of an appropriate hardware device such as an algorithm embedded in a processor or application-specific integrated

FIG. 10 illustrates a block diagram of a computing device such as client computing device, email (electronic message) server, marker generation or injection engine or phishing dropbox detection engine upon and with which embodiments may be implemented. The computing device of FIG. 10 may include a bus 1001 or other communication mechanism for communicating information, and one or more processors 1002 coupled with bus 1001 for processing information. The computing device may further comprise a random access memory (RAM) or other dynamic storage device 1004 (referred to as main memory), coupled to bus 1001 for storing information and instructions to be executed by processor(s) 1002. Main memory (tangible and non-transitory, which terms, herein, exclude signals per se and waveforms) 1004 also may be used for storing temporary variables or other intermediate information during execution of instructions by processor 1002. The computing device of FIG. 10 may also include a read only memory (ROM) and/or other static storage device 1006 coupled to bus 1001 for storing static information and instructions for processor(s) 1002. A data storage device 1007, such as a magnetic disk and/or solid state data storage device may be coupled to bus 1001 for storing information and instructions—such as would be required to carry out the functionality shown and disclosed relative to FIGS. 1-9. The computing device may also be coupled via the bus 1001 to a display device 1021 for displaying information to a computer user. An alphanumeric input device 1022, including alphanumeric and other keys, may be coupled to bus 1001 for communicating information and command selections to processor(s) 1002. Another type of user input device is cursor control 1023, such as a mouse, a trackball, or cursor direction keys for communicating direction information and command selections to processor(s) 1002 and for controlling cursor movement on display 1021. The computing device of FIG. 10 may be coupled, via a communication interface (e.g., modem, network interface card or NIC) to the network 804.

Embodiments of the present invention are related to the use of computing devices to generate, inject and publish markers and to detect phishing dropboxes. According to one embodiment, the methods, devices and systems described herein may be provided by one or more computing devices in response to processor(s) 1002 executing sequences of instructions contained in memory 1004. Such instructions may be read into memory 1004 from another computer-readable medium, such as data storage device 1007. Execution of the sequences of instructions contained in memory 1004 causes processor(s) 1002 to perform the steps and have the functionality described herein. In alternative embodiments, hard-wired circuitry may be used in place of or in combination with software instructions to implement the described embodiments. Thus, embodiments are not limited to any specific combination of hardware circuitry and software. Indeed, it should be understood by those skilled in the art that any suitable computer system may implement the functionality described herein. The computing devices may include one or a plurality of microprocessors working to perform the desired functions. In one embodiment, the instructions executed by the microprocessor or microprocessors are operable to cause the microprocessor(s) to perform the steps described herein. The instructions may be stored in any computer-readable medium. In one embodiment, they may be stored on a non-volatile semiconductor memory external to the microprocessor, or integrated with the microprocessor. In another embodiment, the instructions may be stored on a disk and read into a volatile semiconductor memory before execution by the microprocessor.

While certain example embodiments have been described, these embodiments have been presented by way of example only, and are not intended to limit the scope of the embodiments disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the embodiments disclosed herein.

1. A computer-implemented method, comprising:
receiving, over a computer network, an email comprising a link to a fraudulent website of a counterfeited brand, the fraudulent website comprising at least one login page that comprises at least one field configured to accept user credentials;
determining constraints on the user credentials that must be satisfied for the user credentials to be accepted by the fraudulent website when input into the at least one field;
randomly generating at least some marker elements that satisfy the determined constraints;
using the randomly-generated marker elements, generating fake user credentials that satisfy the determined constraints;
assembling the generated fake user credentials into a marker that is specific to the counterfeited brand and to the fraudulent website;
programmatically inputting the generated fake user credentials into the at least one field of the at least one login page of the fraudulent website; and
publishing the marker injected into the fraudulent website to known email service providers.

2. The computer-implemented method of claim 1, further comprising retrieving, over the computer network, a list of the fraudulent websites from a database of known fraudulent websites, Internet Protocol (IP) addresses for each of the known fraudulent websites, a brand of each of the known fraudulent website and an online status of each of the known fraudulent websites.

3. The computer-implemented method of claim 1, wherein determining constraints comprises consulting a database that stores the constraints, linked to the counterfeited brand, on the user credentials of the fraudulent websites.

4. The computer-implemented method of claim 1, wherein randomly generating the at least some marker elements is carried out such that resultant fake credentials have high entropy.

5. The computer-implemented method of claim 1, wherein the fraudulent website is configured to spoof a well-known website of an existing company, product or brand and wherein generating the fake user credentials and assembling the generating fake credentials into the marker are carried out such that the assembled marker is specific to the existing company, product or brand.

6. The computer-implemented method of claim 1, wherein programmatically inputting the generated fake user credentials comprises executing a selected one of a generic scenario and a brand, product or company-specific scenario, the generic and brand, product or company-specific scenarios determining a manner in which the generated fake user credentials are inputted into the fraudulent website.

7. The computer-implemented method of claim 1, wherein programmatically inputting the generated fake user credentials into the at least one field of the at least one login page of the fraudulent website is carried out only once per IP address.

8. The computer-implemented method of claim 1, wherein assembling further comprises adding the IP address of the fraudulent website and at least a date on which the generated fake user credentials were programmatically inputted into the at least one field of the at least one login page of the fraudulent website.

9. The computer-implemented method of claim 1, wherein publishing comprises sending a copy of the assembled marker to known email providers and a company or brand spoofed by the fraudulent website.

10. The computer-implemented method of claim 1, wherein programmatically inputting the generated fake user credentials into the at least one field of the at least one login page of the fraudulent website is carried out by a web driver process.

11. A computing device comprising:
at least one processor;
at least one data storage device coupled to the at least one processor;
a network interface coupled to the at least one processor and to a computer network;
a plurality of processes spawned by said at least one processor, the processes including processing logic for:
receiving, over a computer network, an email comprising a link to a fraudulent website of a counterfeited brand, the fraudulent website comprising at least one login page that comprises at least one field configured to accept user credentials;
determining constraints on the user credentials that must be satisfied for the user credentials to be accepted by the fraudulent website when input into the at least one field;
randomly generating at least some marker elements that satisfy the determined constraints;
using the randomly-generated marker elements, generating fake user credentials that satisfy the determined constraints;
assembling the generated fake user credentials into a marker that is specific to the counterfeited brand and to the fraudulent website;
programmatically inputting the generated fake user credentials into the at least one field of the at least one login page of the fraudulent website; and
publishing the marker injected into the fraudulent website to known email service providers.

12. The computing device of claim 11, wherein the processes further comprise processing logic for retrieving, over the computer network, a list of the fraudulent websites, Internet Protocol (IP) addresses for each of the known fraudulent websites, a brand of each of the known fraudulent website and an online status of each of the known fraudulent websites.

13. The computing device of claim 11, wherein the processes further comprise processing logic for consulting a database that stores the constraints, linked to the counterfeited brand, on the user credentials of the fraudulent websites.

14. The computing device of claim 11, wherein the processes further comprise processing logic for randomly generating the at least some marker elements such that resultant fake credentials have high entropy.

15. The computing device of claim 11, wherein the fraudulent website is configured to spoof a well-known website of an existing company, product or brand and wherein the processes further comprise processing logic for generating the fake user credentials and assembling the generating fake credentials into the marker such that the assembled marker is specific to the existing company, product or brand.

16. The computing device of claim 11, wherein the processes further comprise processing logic for programmatically inputting the generated fake user credentials by executing a selected one of a generic scenario and a brand, product or company-specific scenario, the generic and brand, product or company-specific scenarios determining a manner in which the generated fake user credentials are inputted into the fraudulent website.

17. The computing device of claim 11, wherein the processes further comprise processing logic for programmatically inputting the generated fake user credentials into the at least one field of the at least one login page of the fraudulent website out only once per IP address.

18. The computing device of claim 11, wherein the processes further comprise processing logic for adding, to the marker being assembled, the IP address of the fraudulent website and at least a date on which the generated fake user credentials were programmatically inputted into the at least one field of the at least one login page of the fraudulent website.

19. The computing device of claim 11, wherein the processes further comprise processing logic for publishing the marker injected into the fraudulent website by sending a copy of the assembled marker to known email service providers and a company or brand spoofed by the fraudulent website.

20. The computing device of claim 11, wherein the processes further comprise processing logic for programmatically inputting the generated fake user credentials into the at least one field of the at least one login page of the fraudulent website using a web driver process.

21. A computer-implemented method of detecting a phishing dropbox, comprising:
receiving a plurality of incoming emails over a computer network, at least some of the received plurality of emails being legitimate emails and at least some of the plurality of received emails comprising stolen user credentials;
receiving at least one email comprising a marker, the marker comprising generated or selected high entropy, random fake user credentials that were previously injected into a fraudulent website;
filtering the incoming emails for one containing data that matches at least portions of the fake user credentials in the received at least one email comprising the marker;
identifying an email address of an incoming email that contains the matching data as being an email address of a phishing dropbox; and
routing the received plurality of emails to respective inboxes, according to email addresses of the received plurality of emails.

22. The computer-implemented method of claim 21, further comprising canceling the email address identified as the phishing dropbox.
